(19) United States
(12) Patent Application Publication
(10) Pub. No.: US 2010/0026939 A1
(43) Pub. Date: Feb. 4, 2010

(54) POLARIZER AND LIQUID CRYSTAL DISPLAY DEVICE

(75) Inventors: Takumi Shibuta, St. Paul, MN (US); Taiichi Sakaya, Chiba-shi (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Chuo-ku, Tokyo (JP)

(21) Appl. No.: 12/519,388

(22) PCT Filed: Dec. 19, 2007
(86) PCT No.: PCT/JP2007/075049

§ 371 Date: Jul. 23, 2009

(30) Foreign Application Priority Data
Dec. 20, 2006 (JP) 2006-342394

(51) Int. Cl. G02F 1/1335; G02B 5/30; G02B 1/08

(52) U.S. Cl. 349/96; 359/491

(57) ABSTRACT

Provided are a polarizer containing a polarizing film having two surfaces opposing each other and one protective film layer, wherein the polarizing film has a resin film with dichroic dye molecules adsorbed on the resin film with uniaxial orientation, wherein the protective film layer is disposed on or over one of the surfaces of the polarizing film, and wherein the polarizer further has, on or over at least one of the surfaces of the polarizing film, an inorganic particle layer containing inorganic particles, and a polarizer having a polarizing film having two surfaces opposing each other and two protective film layers, wherein the polarizing film has a resin film with dichroic dye molecules adsorbed on the resin film with uniaxial orientation, wherein one of the protective film layers is disposed on or over one of the surfaces of the polarizing film and the other protective film layer is disposed on or over the other surface of the polarizing film, and wherein the polarizer further has, on or over at least one of the surfaces of the polarizing film, an inorganic particle layer containing inorganic particles. Furthermore, a liquid crystal display device composed of a combination of the polarizers and a liquid crystal cell is provided.

### TECHNICAL FIELD

The present invention relates to polarizers and liquid crystal display devices.

### BACKGROUND ART

Liquid crystal display devices have been used for a wide variety of display devices on the basis of their advantageous characteristics such as low electric power consumption, high workability at low voltages, light weight, and small thickness. Liquid crystal display devices are made of many components such as a liquid crystal cell, a polarizer, a retardation film, a condensing sheet, a diffusion film, a lightguide plate and a light reflection sheet. Therefore, modifications aiming at improvement in productivity, weight reduction, increase in lightness, etc. have been promoted by reducing the number of constituent films or reducing the thickness of films or sheets.

As to liquid crystal display devices, products which can stand under severe conditions are needed depending on intended applications. For example, liquid crystal display devices for car navigation systems are required to stand severer temperature and humidity conditions in comparison to monitors for normal televisions or personal computers because the temperature or humidity in compartments where the devices are placed may become high. For such applications, polarizers are also required to exhibit high durability. In recent progress in enlargement of the size of liquid crystal display devices, deterioration in image quality due to thermal deformation of a polarizer has been questioned and, therefore, products having high thermal stability have been required.

Polarizers usually have a structure in which a protective film is laminated on both surfaces or one surface of a polarizing film made of a polyvinyl alcohol-based resin with a dichroic dye adsorbed with orientation. Polarizing films are produced by a method which comprises subjecting a polyvinyl alcohol-based resin film to uniaxial drawing in the longitudinal direction and dyeing with a dichroic dye, then applying a boric acid treatment to the film to cause a crosslinking reaction in the film, washing with water, and drying. Usually, iodine or a dichroic organic dye is used as the dichroic dye. A polarizing film prepared in this way is then provided with a protective film on both sides or one side thereof to be converted into a polarizer, which is installed into a liquid crystal display device and then used. Films made of a cellulose acetate-based resin typified by triacetylcellulose are used widely as a protective film. An adhesive made of an aqueous solution of a polyvinyl alcohol-based resin is often used for lamination of a protective film.

As to a polarizer prepared by laminating a protective film onto both sides or one side of a polarizing film having thereon a dichroic dye adsorbed with orientation through an adhesive made of a polyvinyl alcohol-based resin, however, the polarizer may shrink or swell to deform when being used at a high humidity and a high temperature, namely, under humid and hot conditions and, as a result, it may change in hue.

### DISCLOSURE OF THE INVENTION

The present invention provides a polarizer and a liquid crystal display device which are resistant to deformation even in their use under humid and hot conditions.

In one aspect, the present invention relates to a polarizer comprising a polarizing film having two surfaces opposing each other and one protective film layer, wherein the polarizing film comprises a resin film with dichroic dye molecules adsorbed with uniaxial orientation on the resin film, wherein the protective film layer is disposed on or over one of the surfaces of the polarizing film, and wherein the polarizer further has, on or over at least one of the surfaces of the polarizing film, an inorganic particle layer comprising inorganic particles. This polarizer may be referred to as a “single-side-protected polarizer” in the present invention.

In another aspect, the present invention relates to a liquid crystal display device comprising the aforementioned polarizer and a liquid crystal cell, wherein the liquid crystal cell is bonded, with a pressure-sensitive adhesive, to the polarizing film's surface on or over which no protective film is disposed, and wherein the protective film has an in-plane retardation of 20 nm or less.

In another aspect, the present invention relates to a polarizer comprising a polarizing film having two surfaces opposing each other and two protective film layers, wherein the polarizing film comprises a resin film with dichroic dye molecules adsorbed with uniaxial orientation on the resin film, wherein one of the protective film layers is disposed on or over one of the surfaces of the polarizing film and the other protective film layer is disposed on or over the other surface of the polarizing film, and wherein the polarizer further has, on or over at least one of the surfaces of the polarizing film, an inorganic particle layer comprising inorganic particles. This polarizer may be referred to as a “double-side-protected polarizer” in the present invention.

In another aspect, the present invention relates to a liquid crystal display device comprising the double-side-protected polarizer and a liquid crystal cell, wherein one of the protective films in the double-side-protected polarizer has an in-plane retardation of 20 nm or less and the other protective film has an in-plane retardation of greater than 20 nm, and wherein the liquid crystal cell is bonded to the protective film having an in-plane retardation of greater than 20 nm with a pressure-sensitive adhesive.

In another aspect, the present invention further relates to a liquid crystal display device comprising the double-side-protected polarizer and a liquid crystal cell, the double-side-protected polarizer further having a layer made of a retardation film, wherein the retardation film is bonded to one of the protective films with a pressure-sensitive adhesive and the liquid crystal cell is bonded to the retardation film with a pressure-sensitive adhesive.

### BRIEF DESCRIPTION OF THE DRAWINGS

FIG. 1 is a sectional view of one single-side-protected polarizer of the present invention.

FIG. 2 is a sectional view of another single-side-protected polarizer of the present invention.

FIG. 3 is a sectional view of another single-side-protected polarizer of the present invention.

FIG. 4 is a sectional view of another single-side-protected polarizer of the present invention.

FIG. 5 is a sectional view of another single-side-protected polarizer of the present invention.

FIG. 6 is a sectional view of another single-side-protected polarizer of the present invention.

FIG. 7 is a sectional view of one double-side-protected polarizer of the present invention.

FIG. 8 is a sectional view of another double-side-protected polarizer of the present invention.

FIG. 9 is a sectional view of another double-side-protected polarizer of the present invention.

FIG. 10 is a sectional view of another double-side-protected polarizer of the present invention.

FIG. 11 is a sectional view of another double-side-protected polarizer of the present invention.

FIG. 12 is a sectional view of another double-side-protected polarizer of the present invention.

FIG. 13 is a sectional view of another double-side-protected polarizer of the present invention.

FIG. 14 is a sectional view of another double-side-protected polarizer of the present invention.

FIG. 15 is a sectional view of another double-side-protected polarizer of the present invention.

FIG. 16 is a sectional view of one optical compensation polarizer of the present invention.

FIG. 17 is a sectional view of another optical compensation polarizer of the present invention.

FIG. 18 is a sectional view of another optical compensation polarizer of the present invention.

FIG. 19 is a sectional view of one liquid crystal display device of the present invention.

FIG. 20 is a sectional view of another liquid crystal display device of the present invention.

### MODE FOR CARRYING OUT THE INVENTION

The polarizers of the present invention are divided roughly into ones having one protective film layer (single-side-protected polarizers) and ones having two protective film layers (double-side-protected polarizers), which are common in that there is an inorganic particle layer on at least one surface of a polarizing film.

The polarizing film has two surfaces opposing each other and it can exhibit a specified polarization characteristic because the resin film has a dichroic dye adsorbed thereon with orientation. More specifically, dichroic dye molecules have been adsorbed with uniaxial orientation on a resin film. It is possible to control the polarization characteristic by selecting the kind of the resin which constitutes the resin film, the kind and the adsorbed amount of the dichroic dye, etc., appropriately. However, the resin film is usually made of a polyvinyl alcohol-based resin. Usually, iodine and dichroic organic dyes are available as the dichroic dye. Thus, specific examples of the polarizing film include an iodine-based polarizing film prepared by making iodine adsorbed with orientation d on a polyvinyl alcohol-based resin film and a dye-based polarizing film prepared by making a dichroic organic dye adsorbed with orientation on a polyvinyl alcohol-based resin film.

The polyvinyl alcohol-based resin can be obtained by saponifying a polyvinyl acetate-based resin. Polyvinyl acetate, which is a homopolymer of vinyl acetate, and copolymers of vinyl acetate with another monomer copolymerizable with vinyl acetate can be used as the polyvinyl acetate-based resin. Examples of the monomer which is to be copolymerized with vinyl acetate include unsaturated carboxylic acids, olefins, vinyl ethers and unsaturated sulfonic acids. The polyvinyl alcohol-based resin may have been modified. For example, polyvinyl formal, polyvinyl acetal and polyvinyl butyral, which are species having been modified with aldehydes, can be used as a raw material for the saponification.

A polarizing film made of a polyvinyl alcohol-based resin is produced usually via a moisture adjustment step of adjusting the amount of moisture in a polyvinyl alcohol-based resin film, a step of uniaxially drawing the polyvinyl alcohol-based resin film, a step of dying the polyvinyl alcohol-based resin film with a dichroic dye to cause the film to adsorb the dichroic dye, a step of treating the polyvinyl alcohol-based resin film on which the dichroic dye has been adsorbed with orientation, with an aqueous boric acid solution, and a washing step of washing the aqueous boric acid solution away. The uniaxial drawing may be carried out before the dyeing, during the dyeing or during the boric acid treatment after the dyeing. Moreover, the uniaxial drawing may also be carried out in two or more steps mentioned above. As the uniaxial drawing may be employed uniaxial drawing performed between rolls different in circumferential speed or uniaxial drawing performed by using a hot roll. Moreover, dry drawing in which drawing is performed in the air or wet drawing in which drawing is performed in wet condition using a solvent may also be employed. The draw ratio is usually from about 4 to about 8. The thickness of the polyvinyl alcohol-based polarizing film is usually from about 5 to about 50 μm.

The “single-side-protected polarizer” of the present invention includes an embodiment such that a polarizing film has an inorganic particle layer on one surface thereof and an embodiment such that a polarizing film has, on each of both surfaces thereof, an inorganic particle layer. Specific structures of the single-side-protected polarizer of the present invention include an embodiment in which inorganic particle layers are disposed on both surfaces of a polarizing film and a protective film is disposed on one of the inorganic particle layers, an embodiment in which an inorganic particle layer is disposed on one surface of a polarizing film and a protective film is disposed on the inorganic particle layer, and an embodiment in which an inorganic particle layer is disposed on one surface of a polarizing film and a protective film is disposed on the other surface of the polarizing film.

The “double-side-protected polarizer” of the present invention is a polarizer having a polarizing film and two protective film layers, wherein one of the protective film layers is disposed on one surface of the polarizing film, and the other protective film layer is disposed on the other surface of the polarizing film. This polarizer further has an inorganic particle layer on at least one surface of the polarizing film. The inorganic particle layer may be disposed on either one surface or both surfaces of the polarizing film. Specific structures of the double-side-protected polarizer of the present invention include an embodiment in which inorganic particle layers are disposed on both surfaces of a polarizing film and protective films are disposed further on the inorganic particle layers and an embodiment in which an inorganic particle layer and an inorganic particle layer are disposed on one surface of a polarizing film and a protective film is disposed on the other surface of the polarizing film.

A protective film is a film for protecting a polarizing film from an external action and is usually formed of one or more layers made of a thermoplastic resin. Examples of the thermoplastic resin which forms protective films applicable for the present invention include conventional thermoplastic resins which form conventional protective films. Specific examples are cellulose acetate-based resins such as triacetyl cellulose and diacetyl cellulose, polyester-based resins, acrylic resins, polycarbonate-based resins, polypropylene resins, poly(4-methyl-pentene-1) resins, cyclic olefin-based resins obtained by polymerizing norbornene-based monomers such as norbornene and tetracyclododecene. In view of ease in adhering to a polarizing film, optical uniformity, etc., a film made of a cellulose acetate-based resin, especially triacetyl cellulose, is preferable. In the case of using a single layer film made of a cellulose acetate-based resin as a protective film, it is desirable to apply saponification treatment with an aqueous alkali solution to a surface of the film before the lamination to a polarizing film. The thickness of a protective film is usually in the range of from 10 to 200 μm, preferably in the range of from 10 to 120 μm, and more preferably in the range of from 10 to 85 μm. In a liquid crystal display device comprising a polarizer of the present invention and a liquid crystal cell laminated together, a functional layer such as an anti-fouling layer, an anti-reflection layer, an anti-glare layer and a hard coat layer may be present on the surface of a protective layer located on a side opposite to the surface on which the liquid crystal cell is laminated. A protective film made of a thermoplastic resin can be produced by a conventional method, such as T-die extrusion forming, blown film forming, and solvent casting.

The inorganic particle layer referred to in the present invention is a layer formed of inorganic particles piled up. The inorganic particle layer may contain an inorganic binder such as low-melting glass and organosilicon compounds, or a resin binder such as a UV-curable resin.

The thickness of the inorganic particle layer is preferably in the range of from 0.05 to 10 μm, and more preferably from 0.2 to 10 μm from the viewpoint of the effect of restraining the deformation of a polarizer and the strength of the inorganic particle layer.

The method for providing an inorganic particle layer on a polarizing film may be a method in which a coating liquid containing the inorganic particles dispersed in a solvent onto the polarizing film and then removing the solvent. Examples of the method for forming a structure in which an inorganic particle layer is disposed between a polarizing film and a protective film include a method which comprises applying a coating liquid containing inorganic particles dispersed in a solvent onto a protective film, removing the solvent, and then laminating a polarizing film, and a method which comprises applying a coating liquid containing inorganic particles dispersed in a solvent onto a polarizing film, removing the solvent, and then laminating a protective film. The inorganic particles to form an inorganic particle layer are preferably ones which have an aspect ratio of less than 2 and are capable of being dispersed easily in a coating liquid uniformly. If inorganic particles having an excessively large aspect ratio or inorganic particles which are difficult to be dispersed in a coating liquid are used, it may be difficult to form a uniform inorganic particle layer. Examples of inorganic particles which are used for the present invention include silicon oxide, titanium oxide, aluminum oxide, zinc oxide, tin oxide, calcium carbonate, barium sulfate, talc, kaolin, barium sulfate, etc. It is preferable to use silica for reasons that it exhibits satisfactory dispersibility in a coating liquid, that particles thereof are in a true spherical shape and are uniform in particle diameter, and that it has a small birefringence index. It is noted that silica is silicon dioxide.

Although the solvent for use in a coating solution may be a volatile organic solvent, use of water is preferred because it eliminates the need for an explosion-proof structure of a drying system, so that it can reduce the cost. While the amount of inorganic particles in a coating liquid may be determined appropriately depending upon the thickness of the inorganic particle layer to be formed, it is preferably in the range of 1 to 20% by weight.

The inorganic particles contained in an inorganic particle layer are not limited to one kind of particles, and an inorganic particle layer may contain two or more kinds of inorganic particles.

In view of the dispersibility of inorganic particles in a coating liquid and the strength of an inorganic particle layer, it is preferable to use inorganic particles having an average particle diameter in the range of 1 to 300 nm. In view of the transparency of an inorganic particle layer, it is preferable to use inorganic particles having an average particle diameter in the range of 1 to 100 nm. From the viewpoint of the strength of an inorganic particle layer, the inorganic particle layer is preferably made of particles having a bimodal particle size distribution and it is preferable to use inorganic particles with an average particle diameter of 1 to 30 nm and inorganic particles with an average particle diameter of 40 to 100 nm in admixture. “Average particle diameter” of inorganic particles refers to a particle diameter observed in an image using an optical microscope, a laser microscope, a scanning electron microscope, a transmission electron microscope, an atomic force microscope, etc., an average particle diameter determined by a laser diffraction scattering method, a dynamic light scattering method or a BET method, or an average particle diameter determined by the Sears method.

The dispersibility of inorganic particles in a coating liquid may be improved by some means such as stirring with a stirrer, ultrasonic dispersion, and super-high pressure dispersion (using a super-high pressure homogenizer). It is also permissible to perform pH adjustment of a coating liquid to improve the dispersibility of particles. Moreover, the dispersibility of particles in a coating liquid may also be improved by the addition of an ionic dispersing agent, a nonionic dispersing agent, a surfactant, or the like. Moreover, an organic solvent, such as alcohol, may also be added.

Examples of the method for applying a coating liquid containing an inorganic particle onto a protective film include method of applying the liquid using a roll coater, a reverse roll coater, a gravure coater, a knife coater, a bar coater, etc. It is permissible to apply a pretreatment, such as corona treatment, ozonization, plasma treatment, flame treatment, electron beam treatment, anchor coat treatment, and rinse, to a surface of a resin film prior to the application of a coating liquid.

In the polarizer of the present invention, although a polarizing film and an inorganic particle layer, a polarizing film and a protective film layer, and an inorganic particle layer and a protective film layer, respectively, may be in contact or may be bonded through an adhesive, bonding through an adhesive is usually preferred. Examples of the adhesive to be used for the foregoing purpose include adhesives containing a polyvinyl alcohol-based resin, an epoxy-based resin, a urethane-based resin, a cyanoacrylate-based resin, an acrylamide-based resin, or the like. In order to reduce the thickness of an adhesive layer, it is preferable to use a water-based adhesive, that is, an adhesive prepared by dissolving or dispersing an adhesive component in water. Examples of the adhesive component which can form a water-based adhesive include a water-soluble crosslinking epoxy resin and a urethane-based resin.

Examples of the water-soluble crosslinking epoxy resin include polyamide epoxy resins obtainable by causing epichlorohydrin to react with a polyamide polyamine obtainable through a reaction of a polyalkylene polyamine, such as diethylene triamine and triethylene tetramine, and a dicarboxylic acid, such as adipic acid. Examples of commercially available products of such a polyamide epoxy resin include “SUMIREZ RESIN 650” and “SUMIREZ RESIN 675” available from Sumika Chemtex Co., Ltd.

In the case of using a water-soluble epoxy resin as an adhesive component, it is preferable to mix another water-soluble resin, such as a polyvinyl alcohol-based resin, in order to further improve the applicability and the adhesiveness. The polyvinyl alcohol-based resin may be partially saponified polyvinyl alcohol, completely saponified polyvinyl alcohol, or a modified polyvinyl alcohol-based resin, such as carboxyl group-modified polyvinyl alcohol, acetoacetyl group-modified polyvinyl alcohol, methylol group-modified polyvinyl alcohol, and amino group-modified polyvinyl alcohol. In particular, a saponification product of a copolymer of vinyl acetate and an unsaturated carboxylic acid or a salt thereof, namely, a carboxyl group-modified polyvinyl alcohol is preferably used. The “carboxyl group” referred to herein is a concept encompassing —COOH and its salts.

Examples of commercially available, preferable carboxyl group-modified polyvinyl alcohol include “KURARAY POVAL KL-506”, “KURARAY POVAL KL-318” and “KURARAY POVAL KL-118”, each available from Kuraray Co., Ltd., “GOHSENAL T-330” and “GOHSENAL T-350” each available from Nippon Synthetic Chemical Industry Co., Ltd., “DR-0415” available from DENKI KAGAKU KOGYO KABUSHIKI KAISHA, and “AF-17”, “AT-17” and “AP-17” each available from JAPAN VAM & POVAL CO., LTD.

When an adhesive containing a water-soluble epoxy resin is prepared, an adhesive solution is formed by dissolving in water the water-soluble epoxy resin and other water-soluble resins which may optionally be added, such as a polyvinyl alcohol-based resin. In this case, it is preferable to adjust the concentration of the water-soluble epoxy resin into the range of from about 0.02 to about 2 parts by weight per 100 parts by weight of water. In the case of blending a polyvinyl alcohol-based resin, the amount thereof is preferably adjusted to about 1 to about 10 parts by weight per 100 parts by weight of water, and more preferably about 1 to about 5 parts by weight.

On the other hand, in the case of using an aqueous adhesive containing a urethane-based resin, examples of suitable urethane resins include ionomer type urethane resins, especially polyester-based ionomer type urethane resins. “Ionomer type” referred to herein means that a material is prepared by introducing a small amount of ionic components (hydrophilic components) into a skeleton-forming urethane resin. The polyester-based ionomer type urethane resin is a urethane resin having a polyester skeleton containing a small amount of ionic components (hydrophilic component) introduced therein. Such an ionomer type urethane resin is suitable as a water-based adhesive because it can be emulsified in water directly to afford an emulsion without use of any emulsifier. Examples of commercially available products of a polyester-based ionomer type urethane resin include “HYDRAN AP-20” and “HYDRAN APX-101H” available from Dainippon Ink & Chemicals, Inc., and these are available in the form of emulsion.

When using an ionomer type urethane resin as an adhesive component, it is usually preferable to further incorporate a crosslinking agent, such as an isocyanate-based crosslinking agent. The isocyanate-based crosslinking agent is a compound having at least two isocyanate groups (—NCO) in its molecule, and examples thereof include polyisocyanate monomers such as 2,4-tolylene diisocyanate, phenylene diisocyanate, 4,4′-diphenylmethane diisocyanate, 1,6-hexamethylene diisocyanate and isophorone diisocyanate, and modified polyisocyanates such as adduct forms resulting from addition of two or more molecules of such a monomer to a polyhydric alcohol such as trimethylolpropane, tri-functional isocyanurate forms resulting from isocyanurate ring formation of three diisocyanate molecules occurring at their one-terminal isocyanate groups, and biuret forms resulting from hydration/decarboxylation of three diisocyanate molecules at their one-terminal isocyanate groups. Examples of commercially available isocyanate-based crosslinking agents which can suitably be used include “HYDRAN ASSISTER C-1” available from Dainippon Ink & Chemicals, Inc.

When using a water-based adhesive containing an ionomer type urethane resin, a product obtained by dispersing the urethane resin in water so that the concentration of the resin would be about 10 to about 70% by weight, preferably 20% by weight to 50% by weight is preferred from the viewpoint of viscosity and adhesiveness. When incorporating an isocyanate-based crosslinking agent, the incorporated amount thereof may be appropriately determined so that the amount of the isocyanate-based crosslinking agent would become about 5 to about 100 parts by weight per 100 parts by weight the urethane resin.

The method for bonding a polarizing film and a protective film together to produce a polarizer is not particularly restricted. For example, a method can be used in which a polarizing film is put on a protective film after applying uniformly an adhesive to a surface or surfaces to be bonded of the polarizing film and/or the protective film, then the films are bonded together using a roll or the like, followed by drying. After the lamination, drying treatment is performed, for example, at a temperature of about 60 to about 100° C. In order to further increase adhesion force, it is preferable to perform, after the drying treatment, aging at a temperature slightly higher than room temperature, for example, a temperature of about 30 to about 50° C., for about 1 to about 10 days.

In the preparation of a polarizer, it is preferable to apply corona discharge treatment to a surface of the protective film to which surface the polarizing film is to be bonded. “Corona discharge treatment” is a treatment in which a high voltage is applied to between electrodes and thereby activating a surface of a resin film located between the electrodes is activated. The conditions for corona discharge treatment, which may vary depending upon the type of the electrodes, the distance between the electrodes, voltage, humidity and the type of the resin film used, are preferably adjusted to a distance between the electrodes of 1 to 5 mm and a moving rate of about 3 to 20 m/min, for example. After the corona discharge treatment, a polarizing film is bonded onto the treated surface through an adhesive like that described above.

In the single-side-protected polarizer of the present invention, when the protective film has an in-plane retardation of 20 nm or less, preferably 10 nm or less, it is possible to obtain a liquid crystal display device by bonding a liquid crystal cell onto the polarizing film's surface having thereon no protective film. Liquid crystal cells are devices having two glass plates located at a given distance and a liquid crystal material filled in between the glass plates. Particulars of a liquid crystal cells are not critical in the present invention. It is not necessarily required to laminate a protective film to both surfaces of a polarizing film because a glass plate forming a liquid crystal cell can function also as a protective film. It therefore is possible to make a liquid crystal display device have a reduced thickness by combining the one-side-protected polarizer of the present invention with a liquid crystal cell. A cellulose acetate-based resin, such as triacetyl cellulose and diacetyl cellulose, is suitably used as a protective film having an in-plane retardation of 20 nm or less.

Examples of the pressure-sensitive adhesive to be used for bonding a polarizer to a liquid crystal cell include pressure-sensitive adhesives containing base polymers such as an acrylic acid ester-based polymer, a methacrylic acid ester-based polymer, a butyl rubber-based polymer and a silicone-based polymer. A polymer containing as a base component a (meth)acrylic acid ester such as butyl (meth)acrylate, ethyl (meth)acrylate, isooctyl (meth)acrylate and 2-ethylhexyl (meth)acrylate, or a polymer based on a copolymer prepared by using two or more kinds of such (meth)acrylic acid esters is used suitably. In ordinary pressure-sensitive adhesives, their base polymer contains polar monomers copolymerized. Examples of such monomers include monomers having a carboxyl group, a hydroxyl group, an amino group or an epoxy group, such as (meth)acrylic acid, 2-hydroxyethyl (meth)acrylate, 2-hydroxypropyl (meth)acrylate, (meth)acrylamide, N,N-dimethylaminoethyl (meth)acrylate and glycidyl (meth)acrylate. In order to promote curing of a pressure-sensitive adhesive, a crosslinking agent may be added to the a pressure-sensitive adhesive. Examples of the crosslinking agent include agents which are capable of producing a di- or more valent metal ion and a metal salt of a carboxylic acid, agents which are capable of forming an amide linkage together with polyisocyanate compounds. One or two or more of such compounds are used as a crosslinking agent(s) in the form of a mixture with a base polymer. The thickness of the pressure-sensitive adhesive layer is generally from about 2 to about 50 μm. In the case of applying a pressure-sensitive adhesive to a protective film of a polarizer, surface treatment, such as corona treatment, may be added to the surface of the protective film beforehand.

The “double-side-protected polarizer” of the present invention may, when both the protective films have an in-plane retardation of 20 nm or less, preferably 10 nm or less, be a polarizer which further has a layer made of a retardation film and one of the protective films and the retardation film are bonded together with a pressure-sensitive adhesive. A polarizer having such a structure has an optical compensation function and therefore it may henceforth be referred to as an “optical compensation polarizer.” As the retardation film can be used a retardation film having an in-plane retardation of greater than 20 nm. For example, drawn films made of polycarbonate-based resins, polyester-based resins such as polyethylene terephthalate and polyethylene naphthalate, poly(ethylene sulfide)-based resins, acrylic resins such as poly(methyl methacrylate), cyclic olefin-based polymers obtainable by polymerizing norbornene-based monomers such as norbornene and tetracyclododecene, polystyrene-based resins, polypropylene-based resins, etc. can be used.

The optical compensation polarizer can be converted into a liquid crystal display device by being laminated with a pressure-sensitive adhesive to a liquid crystal cell. As the pressure-sensitive adhesive can be used the aforementioned pressure-sensitive adhesive.

In the “double-side-protected polarizer” of the present invention, it is also permissible that one of the protective films has an in-plane retardation of 20 nm or less and the other protective film has an in-plane retardation of greater than 20 nm. In this case, the protective film having an in-plane retardation of greater than 20 nm has a function as a retardation film. Therefore, the polarizer having such a structure is also an “optical compensation polarizer.” Thus, when one of the protective films has an in-plane retardation of 20 nm or less and the other protective film has an in-plane retardation of greater than 20 nm, a liquid crystal display device can be obtained in which the polarizer and a liquid crystal cell have been laminated together with a pressure-sensitive adhesive. As the pressure-sensitive adhesive, the aforementioned pressure-sensitive adhesive can be used. When combining such an optical compensation polarizer with a liquid crystal cell to produce a liquid crystal display device, it is possible to make the liquid crystal display device have a reduced thickness because there is no need to laminate a retardation film. When one of the protective films has a function as a retardation film as mentioned above, it is necessary to bond the protective film having a function as a retardation film to a liquid crystal cell through a pressure-sensitive adhesive.

As the protective film having a function as a retardation film, a film which is optically uniform in birefringence and obtainable by drawing orientation like that disclosed in JP-A 8-43812 is used. Examples of the resin which forms the film include polyvinyl alcohol-based resins, polycarbonate-based resins, polystyrene-based resins, cyclic olefin-based resins obtained by polymerizing norbornene-based monomers such as norbornene and tetracyclododecene, polystyrene-based resins and polypropylene-based resins.

In a liquid crystal display device, polarizers are bonded on both sides of a liquid crystal cell. As to the polarizers bonded to the liquid crystal cell, an intended purpose can be attained if at least one of the polarizers is a component having a retardation function. Concrete constitutions are as follows. In the constitutions (1) to (7), “polarizer” refers to a double-side-protected polarizer, both the protective films of which have an in-plane retardation of 20 nm or less, and “semipolarizer” refers to a single-side-protected polarizer comprising a polarizing film and a protective film having an in-plane retardation of 20 nm or less laminated on one side of the polarizing film. “Optical compensation polarizer” refers to a double-side-protected polarizer in which one of the protective films has an in-plane retardation of 20 nm or less and the other protective film has an in-plane retardation of greater than 20 nm or a polarizer obtained by laminating a retardation film onto one of the protective films of the aforesaid “polarizer.” Adhesive layers and pressure-sensitive adhesive layers disposed between individual layers are not shown.

(1) Polarizer/liquid crystal cell/optical compensation polarizer

(2) Semipolarizer/liquid crystal cell/optical compensation polarizer

(3) Optical compensation polarizer/liquid crystal cell/optical compensation polarizer

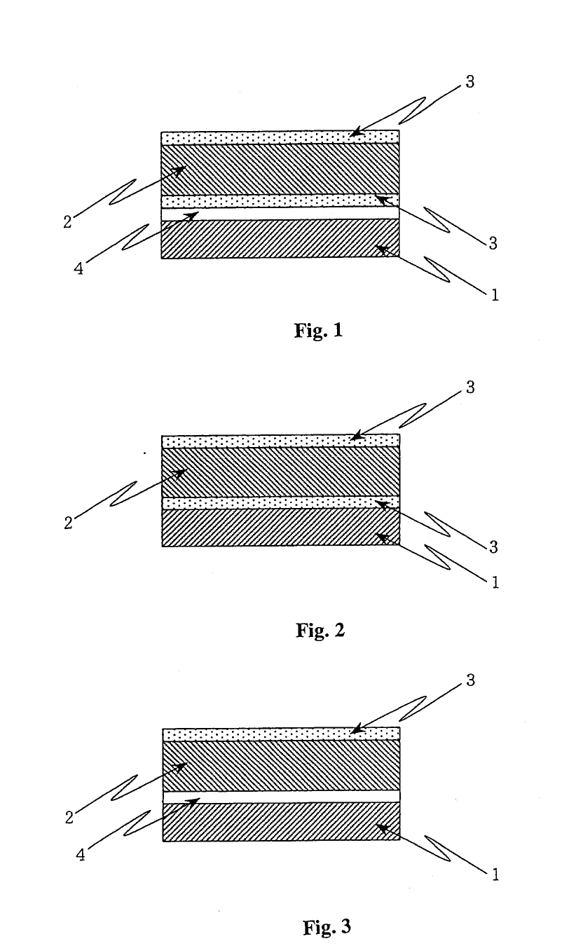

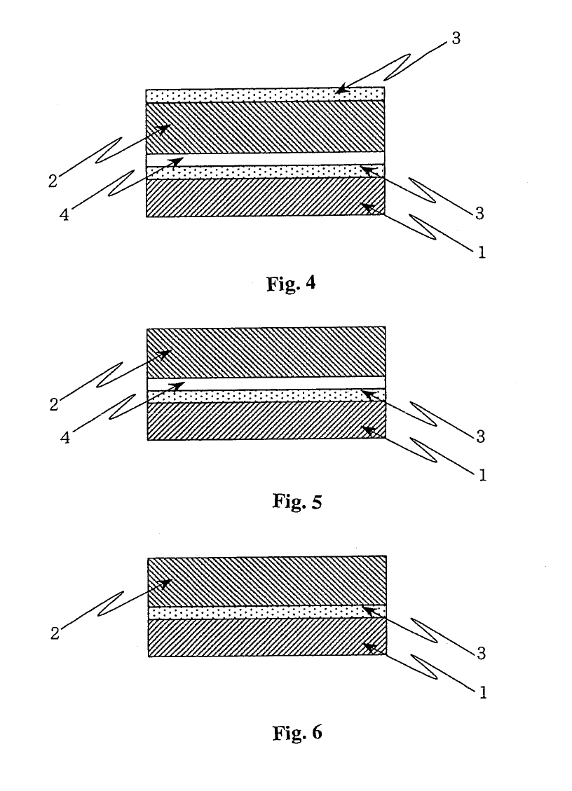

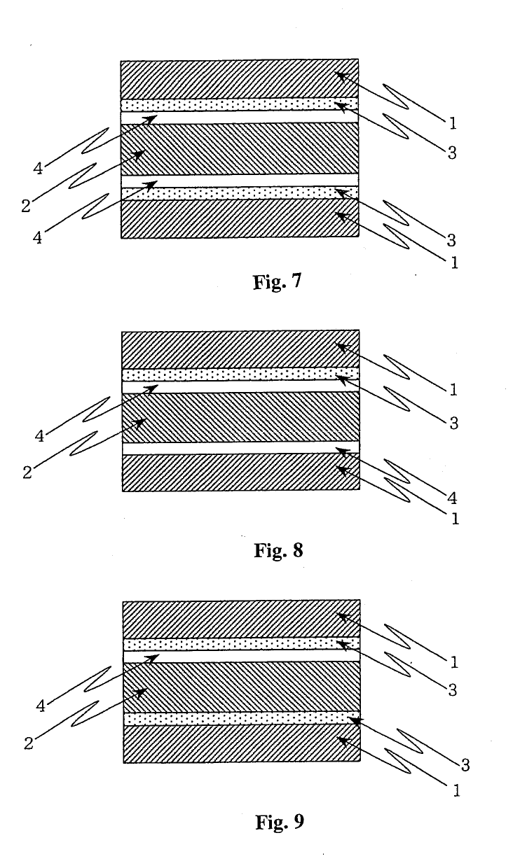

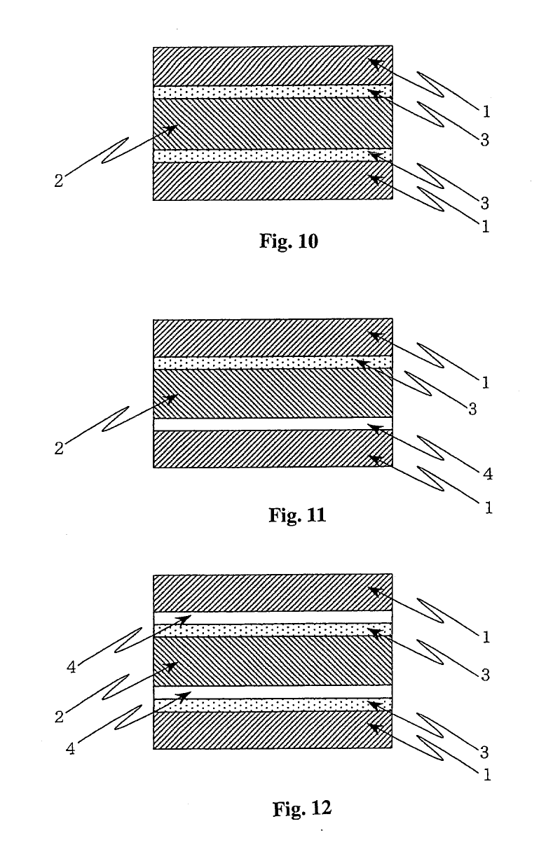

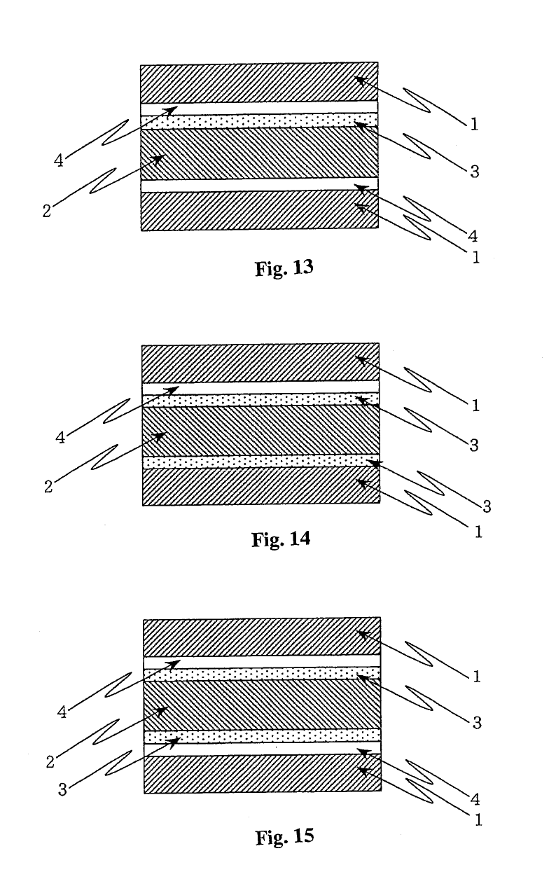

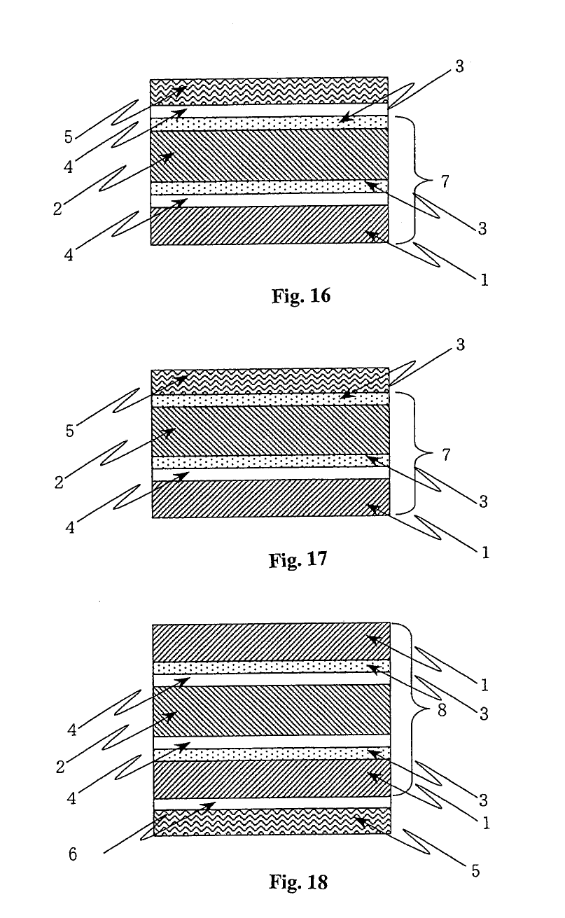

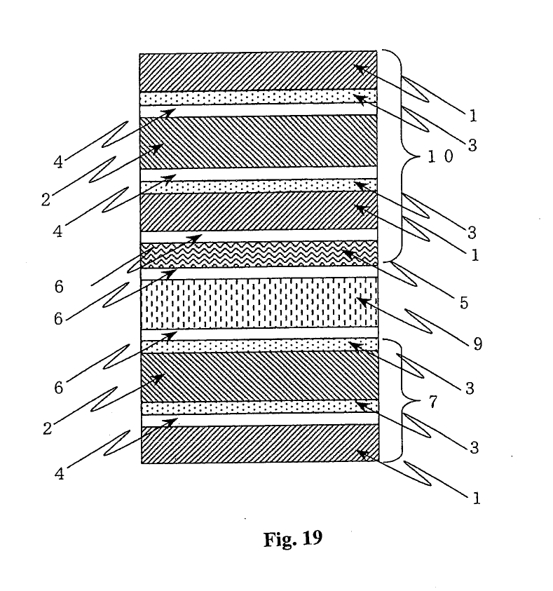

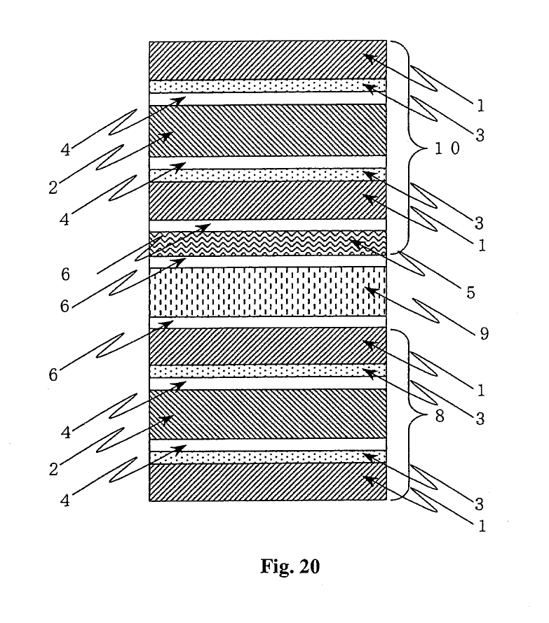

Examples of the polarizers of the present invention are illustrated in FIG. 1 to FIG. 18, and examples of the liquid crystal display devices of the present invention are illustrated in FIG. 19 and FIG. 20. In the drawings, referential numeral 1 represents a protective film, 2 represents a polarizing film, 3 represents an inorganic particle layer, 4 represents an adhesive layer, 5 represents a retardation film or a protective film having an in-plane retardation of greater than 20 nm, 6 represents a pressure-sensitive adhesive layer, 7 represents a single-side-protected polarizer, 8 represents a double-side-protected polarizer, 9 represents a liquid crystal cell, and 10 represents an optical compensation polarizer.

### EXAMPLES

The present invention will be described more concretely below with reference to Examples, but the invention is not limited by the Examples. In the Examples, all % and parts indicating contents or used amounts are by weight unless otherwise stated. In-plane retardations of films were measured using an automatic birefringence analyzer “KOBRA-21DH” manufactured by Oji Scientific Instruments.

### Example 1

### (a) Preparation of a Protective Film Having an Inorganic Particle Layer

First, 650 g of colloidal silica produced by Nissan Chemical Industries, Ltd. (SNOWTEX ST-XS (average particle diameter measured by the Sears method=4 to 6 nm, solid concentration=20% by weight)) and 1300 g of colloidal silica produced by the Nissan Chemical Industries, Ltd. (SNOWTEX ST-ZL (average particle diameter measured by the laser diffraction scattering method=78 nm, solid concentration=40% by weight)) were weighed out, mixed with 4550 g of water, and stirred. Thus, an inorganic particle dispersion liquid was prepared. The inorganic particle dispersion liquid was applied to a thermoplastic resin layer, i.e., a triacetylcellulose film (thickness=80 μm, in-plane retardation=1 nm) produced by FujiFilm Corporation using a microgravure roll (manufactured by Yasui Seiki Co., Ltd., 120 meshes), followed by drying at 60° C. On the resulting laminate, the operations of the application and the drying were repeated nine times, respectively to afford a protective film composed of the thermoplastic resin layer and an inorganic particle layer formed thereon. The thickness of the inorganic particle layer determined with a scanning electron microscope was 2.9 μm. Because the birefringence index of the inorganic particle layer made of silica can be considered to be zero, the in-plane retardation of the protective film is 1 nm.

### (b) Preparation of a Polarizer

On the polyvinyl alcohol layer of the polarizing film having on one side the triacetylcellulose film (in-plane retardation=1 nm) bonded, the foregoing protective film washed with pure water was bonded so that the inorganic particle layer would be located on the polarizing film side, with an adhesive composed of a 5 wt % aqueous solution of POVAL produced by Kuraray Co., Ltd. and then dried at 40° C. for 2 hours. Thus, a protective film having on one side an inorganic particle layer was obtained.

### (c) Evaluation of Stability Under Humid and Hot Conditions

The foregoing polarizer was cut into a size of 5 cm×5 cm and then was held in an oven containing a humid and hot atmosphere of 60° C. and a humidity of 90%, for 30 minutes. Then, the polarizer was taken out of the oven, immediately followed by measurement of the warpage thereof. As a result, the warpage before the treatment and that after the treatment were 5 mm and 7 mm, respectively, and therefore the change in warpage was +2 mm.

### Comparative Example 1

### (a) Preparation of a Polarizer

On the polyvinyl alcohol layer of a polarizing film having on one side a triacetylcellulose film bonded, a triacetylcellulose film (80 μm in thickness) was bonded with an adhesive composed of a 5 wt % aqueous solution of POVAL produced by Kuraray Co., Ltd. and then dried at 40° C. for 2 hours, affording a polarizer.

### (b) Evaluation of Stability Under Humid and Hot Conditions

The foregoing polarizer was cut into a size of 5 cm×5 cm and then was held in an oven containing a humid and hot atmosphere of 60° C. and a humidity of 90%, for 30 minutes. Then, the polarizer was taken out of the oven, immediately followed by measurement of the warpage thereof. As a result, the warpage before the treatment and that after the treatment were 8 mm and 15 mm, respectively, and therefore the change in warpage was +7 mm.

### INDUSTRIAL APPLICABILITY

Polarizers of the present invention are resistant to deformation even in use under humid and hot conditions and, therefore, liquid crystal display devices of the present invention containing such polarizers are resistant to hue change. Therefore, such polarizers and liquid crystal display devices are suitably applied to information instruments to be used under humid and hot conditions.

1. A polarizer comprising a polarizing film having two surfaces opposing each other and one protective film layer, wherein the polarizing film comprises a resin film with dichroic dye molecules adsorbed on the resin film with uniaxial orientation, wherein the protective film layer is disposed on or over one of the surfaces of the polarizing film, and wherein the polarizer further has, on or over at least one of the surfaces of the polarizing film, an inorganic particle layer comprising inorganic particles.

2. The polarizer of claim 1, wherein the inorganic particles have an average particle diameter in the range of from 1 to 300 nm and the inorganic particle layer has a thickness in the range of from 0.05 to 10 μm.

3. The polarizer of claim 1, wherein the inorganic particles are silica particles.

4. The polarizer of claim 1, wherein the protective film has an in-plane retardation of 20 nm or less.

5. A liquid crystal display device comprising the polarizer of claim 4 and a liquid crystal cell, wherein the liquid crystal cell is bonded with a pressure-sensitive adhesive to the polarizing film's surface on or over which no protective film is disposed.

6. A polarizer comprising a polarizing film having two surfaces opposing each other and two protective film layers, wherein the polarizing film comprises a resin film with dichroic dye molecules adsorbed on the resin film with uniaxial orientation, wherein one of the protective film layers is disposed on or over one of the surfaces of the polarizing film and the other protective film layer is disposed on or over the other surface of the polarizing film, and wherein the polarizer further has, on or over at least one of the surfaces of the polarizing film, an inorganic particle layer comprising inorganic particles.

7. The polarizer of claim 6, wherein each of the protective films has an in-plane retardation of 20 nm or less.

8. The polarizer of claim 8, wherein one of the protective films has an in-plane retardation of 20 nm or less and the other protective film has an in-plane retardation of greater than 20 nm.

9. The polarizer of claim 7 further comprising a layer of a retardation film, wherein the retardation film is bonded with a pressure-sensitive adhesive to the polarizer.

10. A liquid crystal display device comprising the polarizer of claim 8 and a liquid crystal cell, wherein the liquid crystal cell is bonded with a pressure-sensitive adhesive to the protective film having an in-plane retardation of greater than 20 nm.

11. A liquid crystal display device comprising the polarizer of claim 9 and a liquid crystal cell, wherein the liquid crystal cell is bonded with a pressure-sensitive adhesive to the retardation film.
